(19) United States
(12) Patent Application Publication
(10) Pub. No.: US 2015/0346115 A1
(43) Pub. Date: Dec. 3, 2015

(54) 3D OPTICAL METROLOGY OF INTERNAL SURFACES

(71) Applicants: Eric J. Seibel, Mercer Island, WA (US); Yuanzheng Gong, Seattle, WA (US); Fred Braun, Wapakoneta, OH (US); David L. Gourley, Marysville, OH (US)

(72) Inventors: Eric J. Seibel, Mercer Island, WA (US); Yuanzheng Gong, Seattle, WA (US); Fred Braun, Wapakoneta, OH (US); David L. Gourley, Marysville, OH (US)

(21) Appl. No.: 14/727,641

(22) Filed: Jun. 1, 2015

Related U.S. Application Data
(60) Provisional application No. 62/005,604, filed on May 30, 2014.

(51) Int. Cl. G01N 21/954; G06K 9/62; H04N 5/225; H04N 13/00; G01N 21/88; H04N 13/02

(52) U.S. Cl. CPC G01N 21/954; G01N 21/8851; H04N 13/0207; H04N 5/2256; H04N 13/0051; H04N 13/0055; G06K 9/6202; H04N 13/0282; G01N 2021/9546; G01N 2201/06113; G01N 2201/08; G01N 2201/101

(57) ABSTRACT

Embodiments regard 3D optical metrology of internal surfaces. Embodiments may include a system having an imaging device to capture multiple images of an internal surface, including a first image that is captured at a first location on an axial path and a second image that is captured at a second location on the axial path, and a transport apparatus to move the imaging device along the axial path. The system further includes a control system that is coupled with the imaging, wherein the control system is to receive the multiple images from the imaging device and to generate a 3D representation of the surface based at least in part on content information and location information for the multiple images.

### CROSS REFERENCE TO RELATED APPLICATIONS

This United States patent application is related to, and claims priority to U.S. Provisional Patent Application No. 62/005,604 filed May 30, 2014, entitled “3D Optical Metrology of Machined Internal Parts and Improved Method of Forming Composite Reconstructed Images from SFE Video” and having Attorney Docket No. 46968.01US1, the entire contents of which are incorporated herein by reference.

### STATEMENT AS TO FEDERALLY SPONSORED RESEARCH

This invention was made government support under NIH Grant R01 EB016457 awarded by the National Institutes of Health. The government has certain rights in the invention.

### TECHNICAL FIELD

Embodiments relate to techniques for optical metrology. More particularly, embodiments relate to 3D optical metrology of internal surfaces.

### BACKGROUND

In the manufacture of mechanical devices, particularly devices constructed of multiple metal parts, there are commonly machined holes formed in or through multiple parts. In complex manufacturing process such as the manufacture of engines, there are a large number of machined parts including threaded holes in or through the metal parts, where the machining of such machined parts is highly precise and essential to proper and safe operation of the finished product.

However, the machined parts include internal surfaces such as within drilled or tapped holes, and such internal surfaces may be small and difficult to examine. Conventional quality assurance processes for such machined parts are time consuming and often require manual checking of the machined parts. Further, such quality assurance processes commonly do not provide information beyond pass/fail determinations, and thus are of limited use in determining how to improve manufacturing processes.

### BRIEF DESCRIPTION OF THE DRAWINGS

Embodiments are illustrated by way of example, and not by way of limitation, in the figures of the accompanying drawings in which like reference numerals refer to similar elements.

FIG. 1 is an illustration of a 3D optical metrology system according to an embodiment;

FIG. 2 illustrates components of a scanning fiber endoscope for capturing images of internal surfaces according to an embodiment;

FIG. 3 illustrates an axial-stereo vision system for optical metrology in an embodiment;

FIG. 4 is an illustration of a 3D optical metrology system for scanning of internal surfaces according to an embodiment;

FIGS. 5A and 5B provide examples of multiple images of an internal surface captured by a SFE according to an embodiment;

FIG. 6 is a flow chart to illustrate a process for 3D optical metrology according to an embodiment; and

FIGS. 7A and 7B illustrate block matching to locate dense corresponding points in 3D optical metrology according to an embodiment.

### DETAILED DESCRIPTION

In the following description, numerous specific details are set forth. However, embodiments may be practiced without these specific details. In other instances, well-known circuits, structures and techniques have not been shown in detail in order not to obscure the understanding of this description. The following detailed description is made with reference to the figures, which illustrate aspects of the technology disclosed.

In some embodiments, an apparatus, system, or method operates to provide for 3D optical metrology of internal surfaces.

In some embodiments, an optical metrology apparatus, system, or method includes application of a scope (also referred to herein as an imaging device) to provide 3D optical metrology of internal surfaces of machined parts. In some embodiments, the scope is a miniature Scanning Fiber Endoscope (SFE), wherein the scope is used to obtain at least two axial stereo images of the internal surface of a machined part to provide one or more images for a non-contact inspection of such internal surface. In some embodiments, the machine vision may further be applied to provide control for one or more tasks in connection with the manufacture of the machined parts.

The interior portions of a machined part, such as the internal surface of a hole drilled in a part, including tapped holes with internal threads, are challenging to inspect, particularly when the area is very small, such as small drilled holes. Inspection of such surfaces is commonly addressed by a manual inspection of certain sample units, where the manual inspection includes a test of the internal surface.

In some embodiments, inspection of interior portions of machine parts instead utilizes optical metrology of such interior portions. While optical metrology systems and processes are utilized in manufacturing, such conventional systems and processes are generally limited to external surfaces, and thus are not useful for internal surface inspection. In some embodiments, a process for measurement of tiny internal 3D surfaces is performed with operation of a scanning fiber endoscope, the scope obtaining multiple images of an internal surface along an axis through the interior portion, and with data being processed according to an axial-stereo vision algorithm.

In some embodiments, a dense, accurate point cloud for internally machined surfaces is generated utilizing optical metrology to compare with other data (such as corresponding X-ray 3D data). In some embodiments, a resulting quantification is analyzed, such as by the Iterative Closest Points (ICP) algorithm, which is an algorithm for comparing and minimizing the difference between the point cloud and a 3D shape or another point cloud. In some embodiments, the analysis is utilized in one or more processes, including determination whether the machined part contains defects, as a factor in control of an apparatus or system for the machining of parts, and as data for external processing regarding the manufacturing processing. In some embodiments, ICP is used for an initial comparison of a 3D reconstructed model to a base model (such as X-ray data) to obtain a general error between the point clouds. In some embodiments, ICP may also be applied to a local defect in a scanned surface, such as a local defect in the internal surface of a machined hole.

Three-dimensional (3D) metrology is a process that utilizes physical measurement apparatus to quantify the actual sizes or distances for a given object. The generated point cloud can be directly utilized in such applications as virtual design, simulation, reverse engineering, and quality control. Modern 3D metrology includes Coordinate Measurement Machine (CMM), machine vision, laser, x-ray, and other metrology processes. 3D metrology may generally be categorized in two main groups of technologies: contact (including classical methods with probes) and non-contact (including laser, optical, or a combination of these technologies). 3D optical metrology can provide flexibility and high speed in non-contact metrology, particularly with the rapid progress in the development of optoelectronic components and availability of increased computational power.

However, conventional 3D optical metrology systems are generally only usable for external machined surfaces, and not internal machined surfaces. Further, the relatively large size of detectors of current metrology systems restricts the application of such detectors for tiny internally machined parts, such as internal threads produced in industries such as the automotive industry. In a particular example using an embodiment of 3D optical metrology, a 3D reconstruction may be performed of, for example, a drilled and tapped hole in an engine block or other mechanical part. In some embodiments, a 3D reconstruction algorithm based content information and location information for a series of images is utilized to capture physical features of an internal surface, such as threads in a metal block, wherein there are known camera positions and orientation for the camera.

In some embodiments, a novel 3D optical metrology system and process is provided, wherein the system and process may be applied to tiny internal surfaces by utilizing a miniature Scanning Fiber Endoscope (SFE) or other imaging device in an axial-stereo vision apparatus.

In some embodiments, application of 3D optical metrology to manufacturing may include:

(1) Addition to quality control, where conventional quality control testing does not provide for high-resolution imaging of threaded holes, such as 6-14 mm inner diameter;

(2) Provide high-resolution optical image data for:

(a) Measuring percent of thread for threaded surface

(b) Detecting and measuring size and distribution of porosity;

(c) Detecting cracks (including size, extent, depth) for expert inspection;

(d) Generating image of surface finish, color, waviness, and roughness;

(e) Correlating tool cutting direction with image analysis;

(f) Determining grain size and orientation, which is related to the strength of a material; and

(g) Comparing an actual 3D surface to CAD (Computer Aided Design) 3D model for the surface.

Advantages of a particular implementation that includes use of an SFE apparatus for imaging may include:

(1) SFE devices typically provide spiral scanned light with most distortion in the center, which is an area that is less important for drilled and tapped holes;

(2) SFE can scan lines at a high frame rate, which may be greater than 10 KHz (kilohertz), thus allowing for scan circular geometries at high rates without motion artifacts;

(3) SFE is generally laser based and thus can apply interferometric imaging modes, laser light polarization, fluorescence crack and porosity detection, confocal imaging, and other laser diagnostics;

(4) SFE can apply high power laser light to treat surfaces and possibly mark surfaces for identification;

(5) SFE can mitigate specular reflections (mirror-like reflections of light or other radiation from a surface) in multiple ways;

(6) SFE can work with non-visible narrow-band wavelengths and at high laser powers; and

(7) SFE allows for interacting with surfaces in optical non-contact manner.

In some embodiments, an apparatus, system, or process provides for high accuracy image resolution and 3D surface reconstruction using a micro-camera that is small enough to fit inside most machined holes (down to 1 mm diameter), and which can be held on a robotic arm or other mechanism for automated inspection and quality control.

In an example, 3D surface analysis, such as detection of waviness (using spatial frequency analysis) of cut inner surface along the tool cutting direction may be utilized to predict tool forces and wear before breakage or part rejection.

Conventional Quality Control (QC) testing of threaded holes is generally a Go-No Go manual gauging process without any variable or image data. In some embodiments, variable data regarding an internal surface such as a threaded hole may be utilized to provide advantages such as:

(1) Measuring many more variables more rapidly;

(2) Calculating tool wear over time and anticipating part rejection;

(3) Automated operation as substitute for manual gauging, thus reducing labor requirements;

(4) Providing real-time feedback in order to modify cutting to keep parts within specifications;

(5) Allowing for possibility of measuring dimensions immediately after cutting when part is very hot with non-contact optical imaging;

(6) Allowing for measuring anisotropy (directional dependency of properties) to determine surface properties;

(7) Comparing data to product history in a database, which may be utilized to refine quality control.

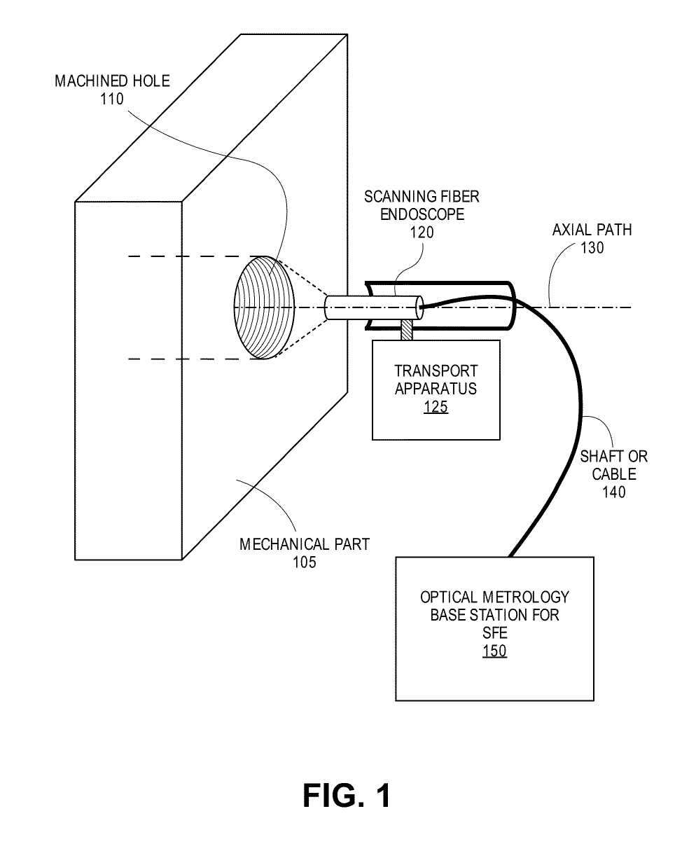

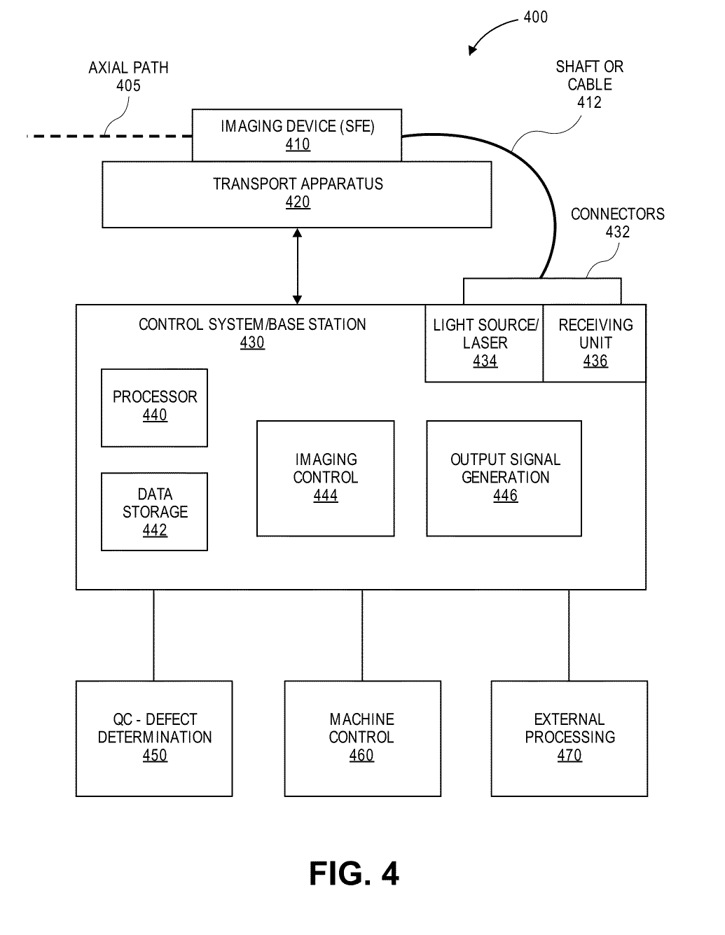

FIG. 1 is an illustration of a 3D optical metrology system according to an embodiment. As illustrated, a miniature Scanning Fiber Endoscope (SFE) 120 is coupled with a shaft or cable 140 to provide light for illumination and to carry signals from images. In some embodiments, the shaft or cable 140 is further coupled with an optical metrology base station 150 to provide for control and processing for the SFE 120. The base station 150 may include the elements illustrated in connection with control system 430 in FIG. 4.

In some embodiments, the SFE 120 is supported by a means for axial transport, illustrated as a transport apparatus 125, in order to move the SFE along an axial path 130 in relation to an interior portion to be scanned. A transport apparatus may include a robotic arm or other automatic mechanism, and is further illustrated and described as transport apparatus 420 in FIG. 4. In an example, the interior portion of a mechanical part 105 includes a machined hole 110 with an internal surface, which may include threads for a screw or bolt, as shown in FIG. 1. In this example, the machined hole 110 may be a through-hole through the mechanical part 105 or may be blind hole that does not go entirely through the mechanical part 105. As illustrated in this example the axial path 130 may be a line through the center of the machined hole 110. However, embodiments are not limited to the scanning of this type of interior portion, and may include other types of internal surfaces that are accessible by an SFE or similar imaging device.

In an example, the transport apparatus 125 may include a means for moving the SFE 120 a known distance along the axial path while retaining a same orientation of the SFE, which may include motor to move the SFE towards or away from the interior portion. In a particular example, the SFE 120 may be attached to a robotic mechanism to align the SFE with the interior portion and to move the SFE along the axial path. However, embodiments are not limited to this particular construction, and may include other mechanisms intended to move the SFE 120 along the axial path 130.

In some embodiments, the SFE 120 is to take two or more images of the interior of the machined hole 110 to provide axial stereo vision of the internal surface of the machined hole, wherein each of the images is taken with the SFE in a same orientation along the axial path 130 or wherein any change in position and orientation between images are known accurately. In some embodiments, the transport apparatus 125, base station 150, or both operating together are to record data regarding the position and orientation of the SFE 120 for each captured image, wherein the orientation data may be used to adjust or modify calculations to reconstruct a 3D image.

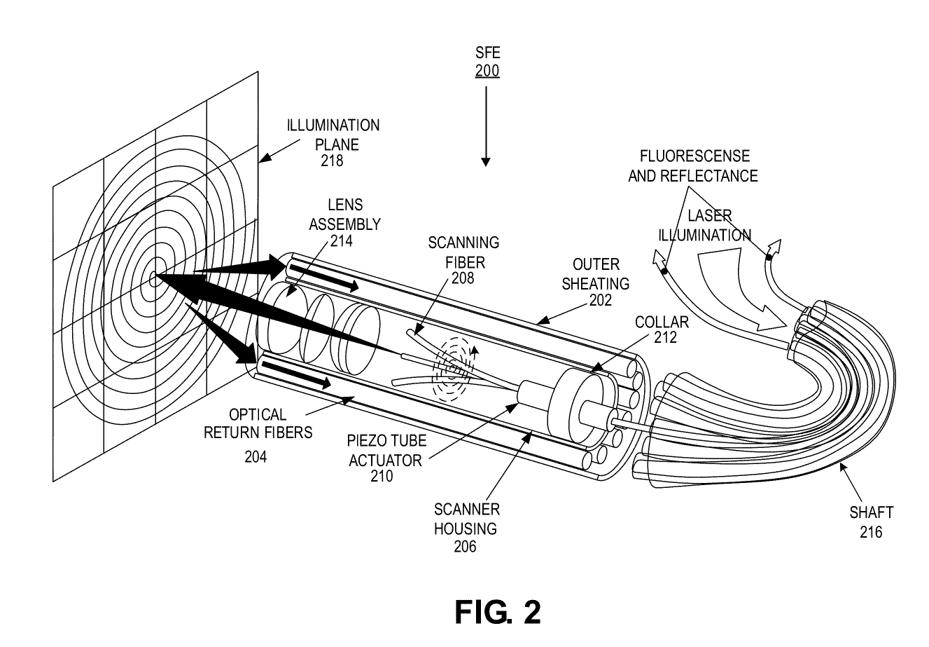

FIG. 2 illustrates components of a scanning fiber endoscope for capturing images of internal surfaces according to an embodiment. In some embodiments, a probe or endoscope, illustrated in FIG. 2 as SFE 200, may be the SFE 120 utilized in scanning as shown in FIG. 1. In some embodiments, the probe or endoscope 200 comprises an outer sheathing 202 enclosing one or more optical return fibers 204 and a scanner housing 206. The scanner housing 206 contains a portion of an illumination scanning fiber 208 coupled at a proximal end to an piezoelectric actuator 210, a collar 212 that holds the piezoelectric actuator 210 in place, and a lens assembly 214 located between the distal end of the illumination scanning fiber 208 and the distal end of the probe 200. The illumination scanning fiber 208 and the optical return fibers 204 may be enclosed in a flexible shaft (or cable) 216 that connects the probe 200 to a base station (not illustrated here), such as base station 150 illustrated in FIG. 1. In other embodiments, certain data may be transferred wirelessly.

When in use, the illumination scanning fiber 216 may be driven by piezoelectric actuator 210 to scan, in a predetermined pattern (e.g., spiral, zigzag), a target area. For purposes of illustration the target area is shown as an illumination plane 218 that is proximate to the distal end of the probe. However, in an embodiment the target area is an internal surface of an interior portion of a part. The target area, shown as the illumination plane 218, may be angled from the axis of the illumination and collection optical fibers by the use of a mirror or prism located distal to the illumination fiber (not shown). The scanned light may go through the lens assembly to reach the target area. Light reflected, refracted, or emitted (e.g., fluorescence) may be collected by the return or collection fibers and transmitted to the base station, such as base station illustrated in FIG. 1, for further analysis and processing.

The SFE is a tiny flexible endoscope. In an example, an endoscope may be approximately 1.2 mm in outer diameter (OD). The SFE is capable of achieving high resolution (such as >500 lines) and wide field of view (70-120 degree FOV, Field of View) with an imaging rate at, for example, 30 Hz. The SFE may generate a full color 2D image from scanning a single beam of RGB (red, green and blue) laser light, for example >10 KHz scan rate in a circular or spiral scan pattern, simultaneously capturing the reflected light by a ring of multimodal return fibers. The SFE may further amplify return signals with photomultiplier tubes (PMTs). Current endoscopic lenses can generate 20-50 micron spatial resolution in luminal spaces from 3-30 mm in diameter. By utilizing a miniature endoscope of this type, the imaging of standard internal threads in a drilled and tapped hole can be achieved with high-resolution in real-time.

While the illustration provided in FIG. 2 illustrates a forward view of the SFE for ease of visualization, the field of view of an SFE 200 or other imaging device is generally much larger than the diameter of the device. For example, in the illustration provided in FIG. 1, the field of view of the SFE 120 may encompass the full inner diameter of the machined hole 110 that is being scanned by the SFE 120.

In some embodiments, to avoid distortion or unwanted detail in the center of images captured by and SFE or other imaging device, the center of the images may be masked, with the outer region (in a “donut” shape) being retained. In other embodiments, rather than utilizing masking, the SFE or other imaging device may scan a portion of the internal surface (such as from an inner diameter to an outer diameter of a machined hole) to avoid the center of images without requiring masking. Advantages of using the donut mask or scanning a portion of internal surface that avoids a center portion when imaging using spiral scanned SFE may include avoiding central distortion and unwanted detail, avoiding motion distortion, providing a faster scanning speed, reducing data load, and requiring less computation time, thus greater efficiency. For example, the >10 KHz spiral scan of a laser light can form 10-line annular images of a sidewall with a >1.4-mm minor diameter of a machined hole at over 1000 frames per second using a current 1.2-mm SFE camera.

Thus, the annular imaging of a fast scanning laser beam can enable very rapid frame rates with reduced area and pixel transmission load. This allows, for example, a robot arm that is transporting the SFE to move continuously from one location to another location to take two images with very little error (due to motion during the image capture time), which can be 1% or less of the total step size. For example moving 1 mm per second and taking 1 image every second, and the SFE annular imaging allows 100 to 100 frames per second, and thus with an error that is 1% to 0.1% in time or axial position of the SFE.

In some embodiments, a stereo vision technique is applied to generate a dense 3D model of an internal surface. Instead of using lateral-stereo (conventional stereopsis), axial-stereo vision is established with at least two SFE images by moving the SFE along with the axis of thread hole while retaining the orientation of the SFE. While the multiple SFE images may include any number of two or more, including a series of video image frames, for clarity of explanation the examples herein generally describe processes utilizing two images.

Stereo vision is an approach to extract 3D information of scene from two images, such as two digital images that captured by two cameras with known spatial positions and orientations. Conventional stereo vision system contains two side-by-side cameras, in a manner similar to human binocular vision. In some embodiments, to satisfy the goals of reducing space, cost, and complexity of examining small restricted spaces such as a threaded hole, a single SFE (monocular vision) is utilized to establish an axial-stereo vision by moving the SFE along the axis of hole to generate the 3D model.

In some embodiments, an SFE may utilize multiple detectors to derive depth information using photometric stereo techniques, which utilize the observation of a surface under different lighting conditions. Using images derived from at least two detectors, and preferably from at least three detectors, the captured images have the same viewpoint with no relative motion and may be simultaneously acquired, but such images have different single source lighting positions. By extracting the depth information, depth cues may be enhanced by calculating the effects of a change in lighting direction.

In an embodiments, a process may include reducing specular reflection in imaging may be provided. In some embodiments, the process may include detecting reflectance or fluorescence with one or more sets of photodetectors and analyzing one or more sets of data associated with the one or more sets of detectors. If any set of data includes saturated data, which is potentially caused by specular reflection, the set of data is disregarded in the formation of a final image.

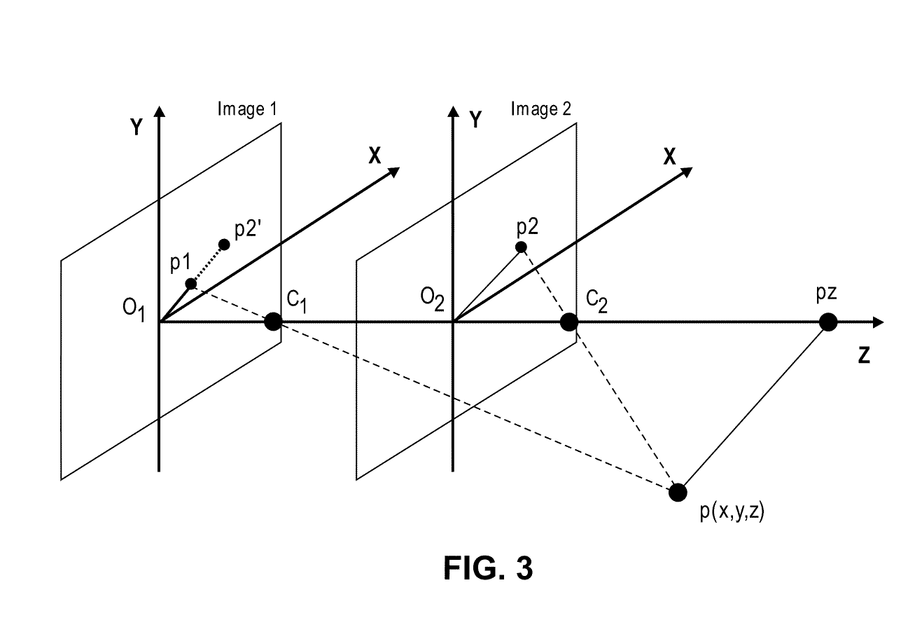

FIG. 3 illustrates an axial-stereo vision system for optical metrology in an embodiment. As illustrated in FIG. 3, Image 1 and Image 2 may represent two images taken by a single camera at two different locations along an axial path or may represent two images taken by two cameras that are arranged along the axial path. As illustrated in FIG. 3:
X, Y, Z: represents the coordinate system in 3D space, where Y (vertical) and X (horizontal) are parallel to the images and Z is orthogonal to the images;
O₁ and O₂: represents the center of the image planes of each image or camera;
C₁ and C₂: represents the pinholes of each image or camera;
P(x,y,z): represents a point in 3D space; and
p1 and p2: represent the projection of P on Image 1 and Image 2.

In some embodiments, a single camera may capture two (or more) images, including images at the camera locations C₁ and C₂, the camera being moved along the Z axis. In alternative embodiments, two (or more) cameras are set up such that the optical axes of the cameras coincide along the Z-axis. In addition, the X and Y axes of the two image planes for either the multiple images by a single camera or images by multiple cameras are kept parallel.

As illustrated in FIG. 3, a point P(x,y,z) in 3D space has projections in two images located at p1 and p2, respectively. Further, p2′ is the orthogonal projection of p2 on the Image 1. O̅₁̅−̅C̅₁̅ and O̅₂̅−̅C̅₂̅ each present the focal length of the SFE, which may be determined from calibration of the instrument. By knowing the distance of O̅₁̅−̅O̅₂̅, which is the distance between the images, the depth information of P can be calculated in the form of disparity ( p̅2̅′̅−̅p̅1̅), which may be obtained by image processing.

From the triangular relationship that is illustrated in FIG. 3, the following equations are satisfied:

$$\begin{matrix}\frac{\overline{p 2 - {O}_{2}}}{\overline{P - {P}_{z}}} = \frac{\overline{{C}_{2} - {O}_{2}}}{\overline{{C}_{2} - {P}_{z}}} & [ 1 ] \\ \frac{\overline{p 1 - {O}_{1}}}{\overline{P - {P}_{z}}} = \frac{\overline{{C}_{1} - {O}_{1}}}{\overline{{C}_{1} - {P}_{z}}} = \frac{\overline{{C}_{1} - {O}_{1}}}{\overline{{C}_{2} - {P}_{z}} + \overline{{C}_{1} - {C}_{2}}} & [ 2 ]\end{matrix}$$

From equations [1] and [2], the equation of depth of P(z), C̅₂̅−̅P̅_̅{̅z̅}̅, may be obtained, which is limited to the unknown variable of disparity:

$$P ( z ) = \overline{{C}_{2} - {P}_{z}} = \frac{\overline{p 1 - {O}_{1}}}{p {2}^{′} - p 1} \times \overline{{O}_{1} - {O}_{2}} \qquad [ 3 ]$$

The X and Y coordinates of P, represented as P(x), P(y), can be calculated with known focal length f_{SFE}:

$$P ( x , y ) = \frac{p 2 ( x , y )}{{C}_{2} - {O}_{2}} \times P ( z ) = \frac{p 2 ( x , y )}{{f}_{SFE}} \times P ( z ) \qquad [ 4 ]$$

In some embodiments, in order to compute the disparity of the projection of each point in the 3D scene, it is necessary to identify the corresponding points in the two axial images. However, in the optical metrology of internal surfaces, such as within the interior of machined metal holes, there are very limited features available for dense matching (where dense matching indicates that every pixel is used to reconstruct the 3D model). In some embodiments, a system or process employs a block matching algorithm to find the corresponding block. In some embodiments, for every pixel in Image 2 of FIG. 3, an n-by-n-pixel block surrounding the pixel is chosen (i.e., the pixel to be searched is at or near a center) and a search is performed around the same location in image 1 over both X and Y directions. The sum of the absolute difference (SAD) is calculated in each block comparison. In some embodiments, the block with the minimum SAD value is determined to be the matching block. Once corresponding points are determined, the 3D information of the scene can be reconstructed by the equations [3] and [4].

Equations [3] and [4] in general assume a constant orientation of a camera or cameras in capturing Image 1 and Image 2. In some embodiments, if the orientation of the camera or cameras may be modified, the reconstruction of the 3D information for the scene may be modified based on the change in orientation. In some embodiments, the change in orientation may be based on data regarding the position and orientation of the camera or cameras that is recorded for each captured image.

FIG. 4 is an illustration of a 3D optical metrology system for scanning of internal surfaces according to an embodiment. In some embodiments, a 3D optical metrology system 400 includes an imaging device such as an SFE 410 (which may be the SFE 200 illustrated in FIG. 2), a transport apparatus 420 to move the imaging device 410 along an axial path in a fixed orientation, and a base station or other control system 430 for the imaging device 410. Transport apparatus 420 may include a robotic arm and/or any other mechanism configured to stably position the imaging device 410 with respect to the mechanical part to be scanned. While the control system 430 is illustrated as a single base station in FIG. 4, embodiments are not limited to this particular implementation, and may include multiple apparatuses.

In some embodiments, the imaging device 410 is coupled with the control system by a shaft or cable 412, which may include the shaft 216 illustrated in FIG. 2 and which may include multiple optical fibers, including one or more scanning fibers to provide illumination and one or more return fibers to receive light for images. The shaft or cable 412 may, for example, be connected via one or more connectors 432 of the control system 430. The control system 430 may include a light source or laser 434 to provide the illumination for imaging, such as the laser illumination transported via shaft 216 in FIG. 2. In some embodiments, the control system 430 includes a receiving unit 436 to receive the image via the return fibers.

In some embodiments, the control system may include additional elements such as a processor 440 to process data for 3D optical metrology; a data storage 442 to store data including image data; an imaging control subsystem or module 444 to control operation of the imaging device 410, which may include control of the transport apparatus 420; and an output signal generation subsystem or module 446 to generate output signals based on the 3D optical metrology. In some embodiments, the control system 430 may provide output signals for varying purposes, which may include, but are not limited to, quality control including defect determination for a machined part 450; machine control, where the 3D optical metrology may be utilized to provide feedback to improve machine operation 460; and external processing 470, such as processing of optical metrology from multiple locations to address overall quality control in a manufacturing system. Variable quality control data derived from 3D optical metrology may be applied in several ways. In some embodiments, the data is used to determine if a machined part is within or outside of the specifications for the machined part. In some embodiments, the data also is used to determine the metrological difference(s) between an acceptable part and the part being measured as well as the location(s) of the respective differences 450. In some embodiments, the variable quality control data is used in machine control 460. The tool wear would be detected by dimensional changes in the machined part. The data could be fed back to the machine control 460 to provide offset information to compensate for the reduced tool size caused by wear. Further, in some embodiments, the variable quality control data is used to predict tool changes. In convention operation, tool changes are typically based on the number of parts machined. In some embodiments, the variable quality control data may instead be applied to project tool changes based on the actual part dimensioning via the external processing 470.

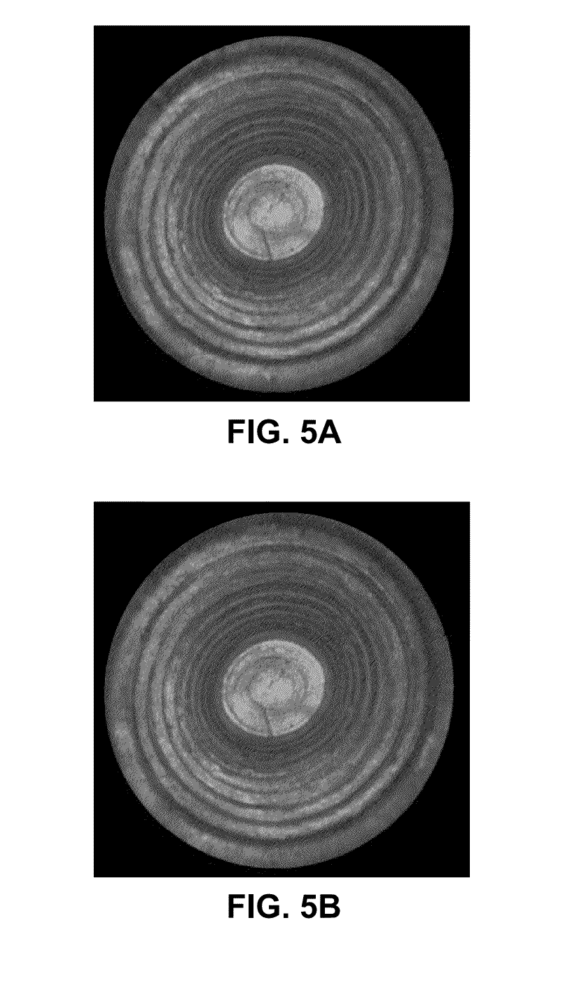

FIGS. 5A and 5B provide examples of multiple images of an internal surface captured by a SFE according to an embodiment. As illustrated, FIG. 5A provides a first image of internal surface of an interior portion of a part, the internal surface in this case being threads of a hole that is drilled and tapped into a machine part. FIG. 5B provides a second image of the same internal surface. In this illustration, the first image is captured by an SFE at a first time and a first location on an axial path into the drilled hole, and the second image is captured by the SFE at a second time and a second location the axial path in a same orientation as the first image. In some embodiments, the first image and the second image are utilized as axial-stereo images to generate a 3D representation of the threads (or other features) of the scanned internal surface.

For two images of different axial depth, as generated by a camera that is moved along an axial path, corresponding points will shift radially, such as the shift between p1 for Image 1 and p2 for Image 2 illustrated in FIG. 3. The points with different depth and radium value shift with different pixel distance. To generate accurate 3D surface reconstruction of threads, dense corresponding points are required, with a main challenge being how to locate dense corresponding points from a series of two or more images. Difficulties include spectral metal surface of the internal area; insufficient texture; and lack of absolute spatial calibration.

In some embodiments, methods to provide for surface feature (such as the front thread surface) reconstruction may include:

(1) SIFT (Scale-Invariant Feature Transform) includes extracting key points from images and finding candidate matching features based on distances of feature vectors. A challenge to applying SIFT is insufficient feature density in an internal surface.

(2) Optical flow utilizes apparent motion of objects, surfaces, and edges in a scene, which presents challenges in reliability because of noise in images of internal surfaces.

(3) HOG (Histogram of Oriented Gradients) includes counting of occurrences of gradient orientation in localized portions of an image.

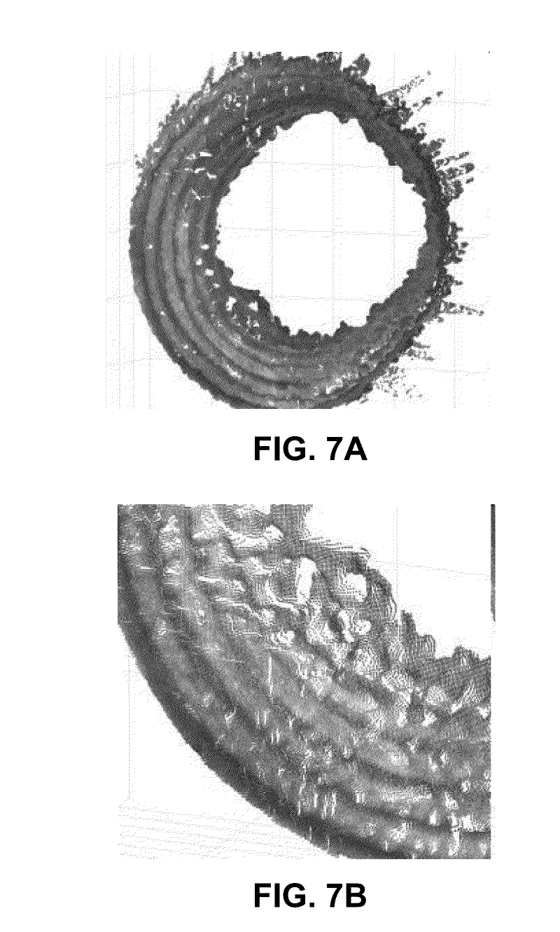

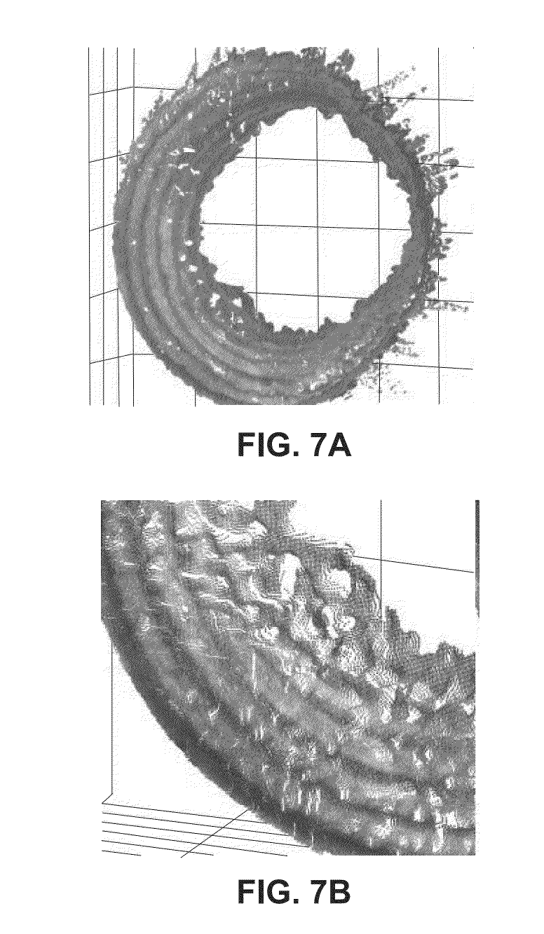

(4) Block matching includes matching blocks of pixels between images. Block matching is illustrated in FIGS. 7A and 7B.

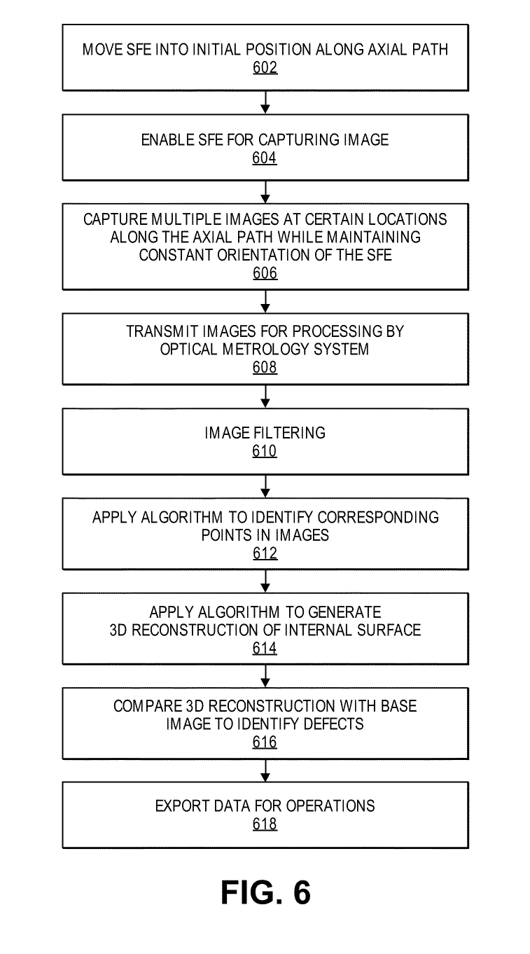

FIG. 6 is a flow chart to illustrate a process for 3D optical metrology according to an embodiment. In some embodiments, a process may include moving an SFE into an initial position for capturing images of interior portions of a machined part 602, such as a threaded hole in a machined part. In some embodiments, moving the SFE into position may include moving a transport apparatus to a position to transport the SFE along an axial path in relation to the interior portion of the machined part. The process may further include enabling the SFE for capturing images 604, which may include enabling a light source or laser for the illumination of the interior space of a machined part.

In some embodiments, the SFE is used to capture multiple images at certain locations or distances along the axial path, while maintaining a certain constant orientation of the SFE in relation to the axial path 606. In some embodiments, an orientation of the SFE may vary, with data regarding the position and orientation of the SFE being recorded to allow for modifying or adjusting calculations based on the captured images. The multiple images include a least a first image taken at a first location on the axial path and a second image take at a second location on the axial path, the first location and second location being a certain distance apart (and possibly having a first orientation and a second different orientation). In some embodiments, the multiple images may include a series of video frames captured as the SFE is transported at a certain constant velocity.

In some embodiments, the images are transmitted by the SFE, such as via optical fibers, for processing by an optical metrology system 608. In some embodiments, the system may provide for certain image filtering to reduce noise in the image data 610.

In some embodiments, an algorithm is applied to the image data to identify corresponding points in images 612. The algorithm may include block matching, as illustrated in FIGS. 7A and 7B, or other point matching algorithm, such as SIFT, optical flow, or HOG algorithms.

In some embodiments, an algorithm is applied to generate a 3D reconstruction of the internal surface of the scanned part 614 based at least in part on content information and location information for the captured images, such as provided by Equations [3] and [4] to calculate the P(z) and P(x, y) values for each point.

In some embodiments, the generated 3D reconstruction may be compared with a base image to identify defects in a scanned part 616. The base image may include an original 3D model for the internal surface. In some embodiments, the process may further include exporting data for other operations 618, such as feedback for machine control, or external processing for overall quality control in a system.

FIGS. 7A and 7B illustrate block matching to locate dense corresponding points in 3D optical metrology according to an embodiment. In some embodiments, multiple images, which may include a sequence of video frames, are captured for purposes of generating a high-resolution, high-accuracy 3D model of the internal surface of a machined part, such as illustrated in FIGS. 1-6. FIG. 7A shows a dense reconstruction of the internal surface of a threaded hole in a machined part. FIG. 7B shows a zoomed in portion of the image shown in FIG. 7A, wherein the dark lines show the edges of the threads in the threaded hole.

In an example, a block size of 7×7 pixels may be chosen to search the corresponding points of the multiple images of an internal surface. The returned disparities of the corresponding points may be integer-valued and noisy. In some embodiments, a sub-pixel correction based on linear interpolation among neighboring pixels may be incorporated to eliminate the integer-valued discontinuity issue, dynamic programming applied to eliminate the noise, and imaging pyramid utilized to guide the block matching.

The 3D reconstruction result may be applied to generate clear images of threads, with the inclusion of texture information that is obtained with the image-based measurement. The image-based measurement thus may provide an advantage in comparison with X-ray 3D metrology, which only generates geometry information. Further, the obtained point cloud can provide more quantitative quality control and monitoring of tool wear comparing with current common method of go/no-go contact gauges, which causes heavier workload, lower efficiency and higher levels of uncertainty depending on the operator's skill

The examples illustrating the use of technology disclosed herein should not be taken as limiting or preferred. This example sufficiently illustrates the technology disclosed without being overly complicated. It is not intended to illustrate all of the technologies disclosed. A person having ordinary skill in the art will appreciate that there are many potential applications for one or more implementations of this disclosure and hence, the implementations disclosed herein are not intended to limit this disclosure in any fashion.

One or more implementations may be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

Other implementations may include a non-transitory computer readable storage medium storing instructions executable by a processor to perform a method as described above. Yet another implementation may include a system including memory and one or more processors operable to execute instructions, stored in the memory, to perform a method as described above.

A computer program product embodiment includes a machine-readable storage medium (media), including non-transitory computer-readable storage media, having instructions stored thereon/in which can be used to program a computer to perform any of the processes of the embodiments described herein. Computer code for operating and configuring a system to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

While concepts been described in terms of several embodiments, those skilled in the art will recognize that embodiments not limited to the embodiments described, but can be practiced with modification and alteration within the spirit and scope of the appended claims. The description is thus to be regarded as illustrative instead of limiting.

In some embodiments, a system includes an imaging device to capture multiple images of an internal surface, including a first image captured at a first location on an axial path and a second image captured at a second location on the axial path; a transport apparatus to move the imaging device along the axial path; and a control system, the imaging device being coupled with the control system, wherein the control system is to receive the multiple images from the imaging device and to generate a 3D representation of the surface based at least in part on content information and location information for the multiple images. In some embodiments, the imaging device is an SFE.

In some embodiments, the imaging device is to provide illumination of the surface and to return light for captured images.

In some embodiments, the illumination includes a laser light.

In some embodiments, the transport apparatus is to maintain an orientation of the imaging device for the multiple images.

In some embodiments, the transport apparatus, the control system, or both are operable to record data regarding a location and orientation for each of the multiple images.

In some embodiments, the first image is captured with the imaging device at a first orientation and the second image is captured with the imaging device at a second orientation, the second orientation being different than the first orientation, and wherein the generation of the 3D representation of the surface is further based on the orientation of the imaging device for each image.

In some embodiments, generating the 3D representation of the surface includes matching a plurality of points of the first image and the second image.

In some embodiments, matching the plurality of points of the first image and the second image includes application of a block matching algorithm.

In some embodiments, a method includes aligning an imaging device with an axial path for an interior portion of a part; capturing with the imaging device a plurality of images of an internal surface of the interior portion of the part at differing locations along the axial path, including capturing a first image at a first location and a second image at a second location; identifying corresponding points in the first image and the second image; and generating an axial stereo 3D representation of the internal surface based at least in part on content information and location information for the first image and the second image. In some embodiments, the imaging device includes an SFE.

In some embodiments, generating the 3D representation of the surface includes matching a plurality of points of the first image and the second image.

In some embodiments, matching the plurality of points of the first image and the second image includes application of a block matching algorithm.

In some embodiments, matching the points of the first image and the second image includes a sub-pixel correction based on linear interpolation among neighboring pixels.

In some embodiments, the method further includes comparing the 3D representation of the surface with a base image to identify defects.

In some embodiments, the method further includes maintaining a certain orientation of the imaging device for the multiple images.

In some embodiments, the method further includes recording data regarding a location and orientation for each of the multiple images. In some embodiments, the first image is captured with a first orientation and the second image is captured with a second orientation, the second orientation being different than the first orientation, wherein the generation of the 3D representation of the surface is further based on the orientation of the imaging device for each image.

In some embodiments, the method further includes deriving variable quality control data based on the generated 3D representation of the internal surface.

In some embodiments, a non-transitory computer-readable storage medium having stored thereon data representing sequences of instructions that, when executed by a processor, cause the processor to perform operations including: aligning an imaging device with an axial path for an interior portion of a part; capturing with the imaging device a plurality of images of an internal surface of the interior portion of the part at differing locations along the axial path, including capturing a first image at a first location and a second image at a second location; identifying corresponding points in the first image and the second image; and generating an axial stereo 3D representation of the internal surface based at least in part on content information and location information for the first image and the second image.

What is claimed is:

1. A system comprising:
an imaging device to capture multiple images of an internal surface, including a first image captured at a first location on an axial path and a second image captured at a second location on the axial path;
a transport apparatus to move the imaging device along the axial path; and
a control system, the imaging device being coupled with the control system;
wherein the control system is to receive the multiple images from the imaging device and to generate a 3D representation of the surface based at least in part on content information and location information for the multiple images.

2. The system of claim 1, wherein the imaging device is a Scanning Fiber Endoscope (SFE).

3. The system of claim 1, wherein the imaging device is to provide illumination of the surface and to return light for captured images.

4. The system of claim 3, wherein the illumination includes a laser light.

5. The system of claim 1, wherein the transport apparatus is to maintain an orientation of the imaging device for the multiple images.

6. The system of claim 1, wherein the transport apparatus, the control system, or both are operable to record data regarding a location and orientation for each of the multiple images.

7. The system of claim 6, wherein the first image is captured with the imaging device at a first orientation and the second image is captured with the imaging device at a second orientation, the second orientation being different than the first orientation, and wherein the generation of the 3D representation of the surface is further based on the orientation of the imaging device for each image.

8. The system of claim 1, wherein generating the 3D representation of the surface includes matching a plurality of points of the first image and the second image.

9. The system of claim 8, wherein matching the plurality of points of the first image and the second image includes application of a block matching algorithm.

10. A method comprising:
aligning an imaging device with an axial path for an interior portion of a part;
capturing with the imaging device a plurality of images of an internal surface of the interior portion of the part at differing locations along the axial path, including capturing a first image at a first location and a second image at a second location;
identifying corresponding points in the first image and the second image; and
generating an axial stereo 3D representation of the internal surface based at least in part on content information and location information for the first image and the second image.

11. The method of claim 10, wherein the imaging device includes a Scanning Fiber Endoscope (SFE).

12. The method of claim 10, wherein generating the 3D representation of the surface includes matching a plurality of points of the first image and the second image.

13. The method of claim 12, wherein matching the plurality of points of the first image and the second image includes application of a block matching algorithm.

14. The method of claim 13, wherein matching the points of the first image and the second image includes a sub-pixel correction based on linear interpolation among neighboring pixels.

15. The method of claim 10, further comprising comparing the 3D representation of the surface with a base image to identify defects.

16. The method of claim 10, further comprising maintaining a certain orientation of the imaging device for the multiple images.

17. The method of claim 10, further comprising recording data regarding a location and orientation for each of the multiple images.

18. The method of claim 17, wherein the first image is captured with a first orientation and the second image is captured with a second orientation, the second orientation being different than the first orientation, and wherein the generation of the 3D representation of the surface is further based on the orientation of the imaging device for each image.

19. The method of claim 10, further comprising deriving variable quality control data based on the generated 3D representation of the internal surface.

20. A non-transitory computer-readable storage medium having stored thereon data representing sequences of instructions that, when executed by a processor, cause the processor to perform operations comprising:
aligning an imaging device with an axial path for an interior portion of a part;
capturing with the imaging device a plurality of images of an internal surface of the interior portion of the part at differing locations along the axial path, including capturing a first image at a first location and a second image at a second location;
identifying corresponding points in the first image and the second image; and
generating an axial stereo 3D representation of the internal surface based at least in part on content information and location information for the first image and the second image.
